(19) United States
(12) Patent Application Publication
(10) Pub. No.: US 2012/0051657 A1
(43) Pub. Date: Mar. 1, 2012

(54) CONTAINMENT COEFFICIENT FOR IDENTIFYING TEXTUAL SUBSETS

(75) Inventors: Charles Lamanna, Bellvue, WA (US); Raja Charu Vikram Kakumani, Kirkland, WA (US); Vidyaraman Sankaranarayanan, Redmond, WA (US); Arnd Christian König, Kirkland, WA (US)

(73) Assignee: MICROSOFT CORPORATION, Redmond, WA (US)

(21) Appl. No.: 12/871,672

(22) Filed: Aug. 30, 2010

(51) Int. Cl. G06K 9/68

(52) U.S. Cl. 382/218

(57) ABSTRACT

Similarity is determined between documents based on a method for identifying documents that are likely to be based on another document. The method can include the determination of a containment coefficient, which can indicate when a template document is a subset or substantially a subset of another document. Based on this determination, an appropriate document management action can be taken, such as implementing a security policy or modifying the display of messages from a user interface.

### BACKGROUND

Data leakage prevention is an ongoing problem for many individuals and corporations. Data leakage prevention can refer to a variety of activities related to controlling or monitoring data access. In addition to preventing intentional misuse, data leakage prevention policies can be designed to modify behavior of authorized users, such as restricting the ability of an authorized user to send sensitive information to an unknown site or computer. Many current efforts to prevent data leakage are focused on identifying the confidential data in an activity. This could involve identifying, for example, that credit card information or a social security number is included within a document, and then controlling or preventing access to the document. Unfortunately, conventional methods for identifying sensitive content can be difficult to implement in practice and can be resource intensive.

### SUMMARY

In various embodiments, methods are provided for determining similarity between documents based on an improved method for identifying documents that are likely to be based on another document. The improved method can include the determination of a containment coefficient, which can indicate relationship between the content of a template document and another document. Based on this determination, an appropriate document management action can be taken, such as implementing a security policy or modifying the display of messages from a user interface.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 schematically shows an example of extracting word units from documents.

FIG. 2 schematically shows an example of performing a document comparison using fingerprints associated with documents.

FIG. 3 depicts a flow chart of a method according to an embodiment of the invention.

FIG. 4 depicts a flow chart of a method according to an embodiment of the invention.

FIG. 5 depicts a flow chart of a method according to an embodiment of the invention.

FIG. 6 is a block diagram of an exemplary computing environment suitable for use in implementing embodiments of the invention.

FIG. 7 schematically shows a network computing environment suitable for use in implementing embodiments of the invention.

### DETAILED DESCRIPTION

### Overview

In various embodiments, methods are provided for determining whether one document is based on another document. The determination can be based on a determination of the likelihood or probability that one document is a subset or substantially a subset of a second document. The determination can be performed using fingerprint values associated with each document. This can allow the comparison to be performed quickly. Performing the determination with fingerprint values can also allow the comparison to be performed using data that does not reveal the original contents of the documents. This can be valuable, for example, in a situation where the template document contains sensitive information. Using fingerprint values can allow the content of the template document to be compared with other documents at a remote location without having to risk exposure of the template document to an outside network. The determination can involve calculating a containment coefficient, which provides an indication of the amount of overlap between two documents.

The ability to determine that one document is based on another document can be used in a variety of situations. For example, many government forms, such as tax forms, are documents that contain blanks or other fields for completion by a person. The text provided by the government is the same for each person that fills out the form. The differences between forms represent input from individuals. In this type of example, a blank government form can be used as a template document, and a comparison can be made between the template document and a second unknown document to determine whether the unknown document is a filled in version of the form. If it is determined that the unknown document is based on the government form, then the unknown document is likely a completed version of the government form that may contain confidential information.

If an effort is made to copy, send, or otherwise use a document based on a template document, the document based on the template can be detected and the activity can be modified or prevented. The action performed can be any convenient document management action. Thus, in the example noted above, detection of a document that is based on a template could be used to prevent the sending of a completed or partially completed government form to an external e-mail address. Alternatively, a warning could simply be provided to a user. Still another option could be to deny access to the document altogether.

In another embodiment, containment coefficients can be used to identify stored or saved documents that match a template document. Optionally, this could be part of a document access policy where documents are classified into various categories. The classification of a document can then be used to determine permitted uses for the document. For example, a company may have an invention disclosure form with a number of standard fields. Under the company's data control policies, an invention disclosure document should include a metatag that identifies the document as belonging to a sensitive category, such as a High Business Impact category. For documents with the High Business Impact metatag, any attempt by a user to send the document to an external e-mail address results in an additional prompt to the user confirming that the document should be sent. In such a company, some inventors may use the original template to construct their own version of an invention disclosure form, such as by cutting and pasting portions of the original template into a new document. This could result in a document that contains invention disclosure information but lacks the appropriate High Business Impact metatag. By using containment coefficients, the storage directories for the inventor can be scanned on a periodic basis to identify documents that match a template, such as the template for the invention disclosure form. When a match is detected, the matching document can be assigned the appropriate metatag.

The discussion below will further describe a method for determining whether a first or template document is the basis for a second document. The threshold for the amount of common content between a template document and another document can be selected based on desired user preferences. In some situations, it may be desirable to have a broad definition for matching document, so that the amount of content in common may only be about 50-60% between the documents. Alternatively, if may be desirable to match documents with a greater degree of content in common. This can be any desired amount up to and including a situation where one document is a subset of a second document.

### Template Documents

In various embodiments, the invention allows for a determination of whether one document is based on another document. This determination can begin by identifying a document that serves as the basis for comparison. This document can be referred to as a template document.

One type of template document can be a document that provides a framework for adding further information. Government forms such as tax forms, employment forms, or motor vehicle registration forms can be examples of template documents. Other examples of template documents can include medical information forms, survey forms, college admission applications, loan documents, customer information forms, invention disclosure forms, or any other document where a known set of text is provided. Still other examples could include forms generated by businesses for customer interaction, such as a form to request service/repair of a car or a computer.

In some instances, the text in a template document can represent a majority of the text found in a document based on the template. In other situations, the amount of text in the template document may be small relative to the total amount of text contained in a document. For example, an invention disclosure form at a corporation can be an example of a template document. An invention disclosure form can contain a series of fields for completion by inventors, so that an invention can be evaluated by management and/or a legal department. Some fields in an invention disclosure form can correspond to short but open ended questions, such as “Describe the problem to be solved” or “Provide a description of your invention.” As a result, the amount of information added to the form may be substantially larger than the original text of the invention disclosure form. In some cases, the additional text can be tens or hundreds of times larger than the original content of the invention disclosure template document.

More generally, a template document can be any document that is used as the basis for determining content in common with another document. Another type of template document can be an e-mail or other document generated by a user, or a document that is in the process of being generated by a user. This type of template document can be referred to as a dynamic template. For example, a user may be in the process of typing an e-mail that includes sensitive information, such as credit card information. During typing of the e-mail, an auto-save feature can attempt to save the e-mail to a remote drive. A data leakage prevention program, or possibly the e-mail program itself, can detect the sensitive information and block the effort to save the e-mail to the remote drive. This can result in a message being displayed to notify the user of the failed save attempt. As the user continues composing the e-mail, the program continues to attempt to auto-save. Each of these further attempts is also blocked, as the sensitive information is still present. The state of the e-mail at the time of the first block of the auto-save can be used as a template document. This template can be compared to the e-mail at the time of the later efforts to auto-save the e-mail, to determine that the same e-mail is being blocked multiple times. Rather than display a separate warning to the user each time the auto-save feature is blocked, the knowledge that the same e-mail is being blocked can be used to suppress some or all of the additional warnings. Note that the content of the e-mail at any point in time could be used as the template document, including the content of the e-mail after one or more failed attempts to perform the auto-save.

More generally, comparison with a template document can be used to improve user interface behavior in a variety of circumstances. For example, a user may attempt to send an e-mail that is not restricted based on the content of the e-mail. However, when the user hits send, transmission of the e-mail may fail for some reason, such as a loss of network connectivity, or due to a delay at a server that is hosting the transmission of the e-mail. In this situation, the user's e-mail program may generate alerts informing the user of each failed effort to send the e-mail. Instead of displaying all of these alerts to the user, the content of the e-mail being sent can be compared between each attempt. Based on a determination that the same or a similar e-mail is resulting in all of the failed send attempts, the number of warnings displayed to the user can be reduced. The reduction in the number of warnings can be based on blocking one or more of the warnings, or the consolidating the warnings and then providing the user with a consolidated message regarding the repeated failures.

It is noted that a template could be based on an existing form that includes some additional text. For example, an employer could start with a standard version of a W-2 tax form. The employer could then add information specific to the employer, such as the employer's address and tax identification number. This modified W-2 form could then be used as a template by the employer, as opposed to using a standard W-2. Similarly, a dynamic template could be based on an existing form, such as a form that is partially completed.

### Creating a Document Fingerprint

In various embodiments, the invention can allow for determination of the likelihood that a first document is based on a second document. In order to make this determination, a similarity between the first document and second document can be determined. This similarity can be used to determine the containment coefficient for a pair of documents. One option for determining a similarity between two documents can be to compare a “fingerprint” for each document. For example, a fingerprint can be created using a minwise hashing calculation. Minwise hashing of a document involves generating sets of hash values based on the word units in each document, and then using selected hash values from the sets to make a comparison between the documents. One variant of minwise hashing is “b-bit” minwise hashing, where a comparison is made between only a truncated number of bits of the selected values.

In various embodiments, such as an embodiment involving use of a minwise hashing calculation, a first step can be to determine the type of word unit that will be used during calculation of the containment coefficient. In a minwise hashing example, the choice of word unit corresponds to the unit that will be hashed. The word unit for hashing can be a single word or two or more consecutive words. Typical choices for the word unit can be one word, two words, or three words. These typical choices, however, are based on efficiency considerations, and larger numbers of words can be used as the word unit if desired. Alternatively, the word unit can be based on a number of consecutive characters, rather than based on words. In such an alternative embodiment, the number of consecutive characters can be based on all text characters (such as all ASCII characters), or the number of characters can exclude non-alphabetic or non-numeric characters, such as spaces or punctuation marks. In such an alternative embodiment, the number of consecutive characters can be about two or more characters, or about three or more characters, or about five or more characters. In an embodiment, the number of consecutive characters can be about 10 or less, or about 15 or less, or about 20 or less, or about 30 or less. Again, the number of consecutive characters used can be based in part on efficiency considerations, so larger numbers of consecutive characters can also be selected. Note that use of a small number of consecutive characters, such as two consecutive characters, may reduce the accuracy of subsequent similarity value calculations due to the finite number of character combinations. For convenience, the examples below will consider use of two consecutive words or a word pair as the word unit, unless otherwise specified.

After selecting the word unit, the word units in a document can be extracted. Extracting word units can include extracting all text within a document. Extraction of word pairs can be used as an example for extracting word units. When word pairs are extracted, each word in a document (except for the first word and the last word) will be involved in two word pairs. For example, consider a document that begins with the words “Patent Disclosure Document. This is an interesting document.” The word pairs for this document will be “Patent Disclosure”, “Disclosure Document.”, “Document. This”, “This is”, and so on. Each word appears as both a first word in a pair and a second word in a pair in order to avoid the possibility that similar documents would appear to be different due to being offset by a single word.

A hash function can then be used to generate a set of hash values based on the extracted word units for a document. In an embodiment where the word unit is a word pair, the hash function is used to generate a hash value for each word pair. Using a hash function on each word pair (or other word unit) will result in a set of hash values for a document. Suitable hash functions can be selected from hash functions that allows word unit to be converted to a number that can be expressed as an n-bit value. For example, a number can be assigned to each character in a word unit, such as the ASCII number for each character. These values can be summed. A hash function can then be used to convert the summed number into a hash value. Alternatively, a hash value could be generated for each character, and then the hash values could be summed to generate a single value for the word unit. Still other methods can be used, so long as the hash methodology for the hash function converts a word unit into an n-bit value. The hash functions can also be selected so that the various hash functions used are min-wise independent of each other. Alternatively, several different types of hash functions can be selected, so that the resulting collection of hash functions is approximately min-wise independent.

The hashing of word units in a document can be repeated using a plurality of different hash functions. Each of the plurality of hash functions allows for creation of different set of hash values. The hash functions can be used in a predetermined sequence, so that the same sequence of hash functions is used on each document that is being compared. This results in an ordered series or sequence of hash value sets. Some hash functions may differ based on the functional format of the hash function. Other hash functions may have similar functional formats, but differ based on internal constants used within the hash function. The number of different hash functions used on a document can vary, and can be related to the number of words (or characters) in a word unit. In some embodiments, the number of different hash functions can be at least about 25, or at least about 100, or at least about 250, or at least about 500, or at least about 1000. The number of different hash functions can be about 25,000 or less, or about 10,000 or less, or about 2500 or less, or about 1500 or less. The result of using the plurality of hash functions is a plurality of sets of hash values. The size of each set is based on the number of word units. The number of sets is based on the number of hash functions. As noted above, the plurality of hash functions can be applied in a predetermined sequence, so that the resulting hash value sets correspond to an ordered series or sequence of hash value sets.

For each set of hash values, a characteristic value can be selected from the set. For example, one choice for a characteristic value can be the minimum value from the set of hash values. Techniques for determining a minimum value from a set of values are well known. The minimum value from a set of numbers does not depend on the size of the set or the location of the minimum value within the set of numbers. The maximum value of a set could be another example of a characteristic value. Still another option can be to use any technique that is consistent in producing a total ordering of the set of hash values, and then selecting a characteristic value based on the ordered set.

The characteristic value can then be used as the basis for a fingerprint value. The characteristic value can be used directly, or the characteristic value can be transformed to form the fingerprint value. The transformation can be a transformation that modifies the characteristic value in a predictable manner, such as performing an arithmetic operation on the characteristic value. Still another option can be to truncate the number of bits in the characteristic value, such as by using only the least significant b bits of the characteristic value.

The fingerprint values generated from the group of hash functions can be assembled into a set of fingerprint values for a document that is ordered based on the original predetermined sequence used for the hash values. This set of fingerprint values is defined as the fingerprint of a document. The document fingerprint can be used to determine a similarity value and subsequently a containment coefficient for a pair of documents. Based on the nature of the fingerprint as an order set of fingerprint values, the fingerprint can be easily stored and compared with other fingerprints. Additionally, depending on the hash methods used and/or any additional transformations of the characteristic values when forming the fingerprint values, in many circumstances the fingerprint cannot be used to determine the contents of the corresponding document. Thus, even though a document may contain sensitive information, the fingerprint for the document can be transmitted through a network or stored at various location without a concern for leakage of the sensitive information.

### Determining Document Similarity

In an embodiment, document fingerprints can be used to determine a similarity between two documents. In set theory, a similarity (referred to as the resemblance) can be defined as

R=|S₁∩S₂|/|S₁∪S₂| (1)

where R is the set resemblance or similarity, S₁ and S₂ are two sets for comparison, and |S| is the cardinality, or the number of items in the set. The set resemblance or similarity R can also be referred to as the Jaccard Similarity Coefficient.

Using fingerprint values, the resemblance or similarity can be estimated based on the probability that, for a given hash function, the fingerprint value generated from the hash function for the first document will be the same as the fingerprint value for the second document. One way of determining this probability is to use many different hash functions and calculate an average. In other words, for each hash function, the hash function is applied to the word units in both documents. The fingerprint value for each document is determined by identifying the minimum value (or other characteristic value). If the fingerprint values match, a value of 1 is assigned. If the fingerprint values don't match, a value of 0 is assigned. By averaging over a plurality of hash functions, a resemblance or similarity value can be calculated.

To provide an example, consider a situation where the characteristic value is a minimum value, and the characteristic value is used without transformation, but optionally with truncation, as the fingerprint value. Mathematically, this can be expressed as

$$\begin{matrix}R = Probability ( min ( π ( {S}_{t} ) ) = min ( π ( {S}_{c} ) ) \\ \approx \frac{1}{k} * {\sum }_{j = 1}^{R} \{ bb ( b , min ( {π}_{j} ( {S}_{t} ) ) , min ( {π}_{j} ( {S}_{c} ) ) ) \}\end{matrix} \qquad ( 2 )$$

where

Sₜ is the set of word units (such as word pairs) contained in the template document;

S_{c} is the set of word units contained in the comparison document;

π is a hash function with random dispersion;

min (S) finds the lowest value in S; and

bb (b, x₁, x₂) equals 1 if a designated number of b bits of x₁ and x₂ match, and 0 otherwise.

In the above formula, if the characteristic value is used without truncation, the designated number of bits “b” will correspond to the number of bits in the characteristic value. If the characteristic value is truncated to form the fingerprint value, the designated number of bits “b” can correspond to the truncated number of bits. The above formula could be further modified to include transformations of the characteristic values by applying further mathematical operations either before or after the hashing function.

Note that depending on the method used, the above equation may require a bias correction. For example, in an embodiment where the fingerprint value is based on selecting a minimum value as a characteristic value and then truncating the number of bits in the characteristic value, the resulting fingerprint value may have a bias toward values with an increased number of “0” bits relative to “1” bits.

Based on the above, a resemblance or similarity value R can be calculated for two documents. The resemblance or similarity value R is a value between 0 and 1. Note that the strict definition of the cardinality for a set would include only the number of unique word units in a set, such as the number of unique word pairs. For the calculations below, a modest improvement in accuracy can be achieved by counting only unique word units when determining the cardinality of a document. However, for a typical document, the number of repeating word units is small relative to the total size of the document. Thus, the total number of word units in a document can be substituted for the total number of unique word units. This substitution will be used in the examples below, unless otherwise noted.

The resemblance R is difficult to use as a predictor of whether a first document is a subset of a second document. It has been discovered that an improved predictor, referred to here as the “containment coefficient”, can be determined based on the resemblance R. In terms of set theory, the containment coefficient can be defined as

Cᵣ=|Sₜ∩S_{c}|/|Sₜ| (3)

After some manipulation, this equation can be recast as:

Cᵣ=[R*(|Sₜ|+|S_{c}|)/(1+R)]/|Sₜ| (4)

When the containment coefficient “Cᵣ” is greater than a threshold value, the smaller document Sₜ can be considered to be a subset (or substantially a subset) of the document S_{c}. If Sₜ is a subset or substantially a subset of S_{c}, then Sₜ can be considered as a template document for S_{c}. The threshold value can be set to a higher or lower value, depending on the desired degree of certainty that Sₜ is a subset of S_{c}. A suitable value for the threshold can be at least about 0.50, or at least about 0.60, or at least about 0.75, or at least about 0.80. In embodiments where it is desirable for one document to approximately be a subset of a second document, values for the threshold of 0.95 or higher or 0.98 or higher can be used. It is noted that truly independently generated documents are likely to have some word units in common. As a result, threshold values of less than about 0.5 or less than about 0.4 may be less desirable, as such values may lead to matching of template documents to documents with unrelated content.

### Alternative Calculations for Similarity and Containment Coefficient

The above describes one method for determining fingerprints for a document and calculating a similarity. Other methods are available for determining a fingerprint and/or a similarity, and using these values to calculate a containment coefficient. For example, the resemblance definition provided above is a known definition from set theory. Other variations on the minwise hashing procedure described above may be available for calculating fingerprints. Another option could be to use other known methods for calculating a resemblance, such as Locality Sensitive Hashing methods. These can include the 1-bit methods known as sign random projections (or simhash), and the Hamming distance LSH algorithm. More generally, other techniques that can determine a Jaccard Similarity Coefficient can be used for determining the set resemblance or similarity. After determining a set resemblance or similarity, a containment coefficient can then be calculated based on the cardinality of the smaller and larger sets.

### Splitting of Large Documents

In some situations, it may be desirable to split a template document or a document the document for comparison into a plurality of sub-documents. A containment coefficient can be determined by generating a containment coefficient for each of the sub-documents involved in the calculation. As an example, consider a situation where a template document is to be compared with a comparison document that has been split into two or more sub-documents. A fingerprint can be determined for the template document and for each of the sub-documents. The sub-document fingerprints can be used to determine a resemblance between each of the sub-documents and the template document. The resemblance values can then be used to calculate a containment coefficient for the template document relative to each of the sub-documents.

At this point, the containment coefficients for the template document relative to the sub-documents may be sufficient for determining that a document management action should be performed. For example, if the containment coefficient for the template document relative to one of the sub-documents is above a threshold value, this can indicate that the sub-document is based on the template. The threshold value can be selected from the threshold values as described above. If the containment coefficient for the template document is greater than the threshold value, a document management action can be performed, such as adding a classification to the document, preventing access to the document, or any other suitable document management action.

Another option can be to determine a containment coefficient for the entire document. To do this, a containment coefficient can be calculated for each of the sub-documents relative to the other sub-documents. An overall containment coefficient for the template document relative to the full comparative document can then be determined. The plurality of containment coefficients between the template document and the sub-documents can be summed. However, to the degree that the same word unit(s) may appear in more than one document, a correction factor is needed based on duplicate counting. From a mathematical standpoint, the containment coefficient is based in part on a sum of the intersections between the template document and the various sub-documents. The correction is to subtract out the intersection of each unique pair of template/sub-document intersections.

For example, in an embodiment where the containment coefficient is calculated based on fingerprint values, the correction factor can be determined based on comparing the fingerprint values that were matched between the template document and each of the sub-documents. For example, in a situation where a template is compared to two sub-documents, a first group of template fingerprint values can match with the first sub-document (the first intersection group) while a second group of fingerprint values can match with the second sub-document (the second intersection group). The correction factor can be generated by determining the intersection between the first intersection group and the second intersection group. This intersection or correction factor can be determined in a manner similar to determining a containment coefficient, but only comparing the fingerprint values that were previously matched to the template document. In the formula for determining R described above, a value of “0” (or no match) would be assigned for any fingerprint value for either the first sub-document or the second sub-document that was not a match for the template document. Thus, the correction factor excludes any potential matches between the sub-documents that are based on values that did not match the template document. This correction factor can be subtracted from the sum of the containment coefficients, resulting in a combined value corresponding to an overall containment coefficient.

It is noted that splitting a larger document into sub-documents can improve the accuracy of the containment coefficient calculation if the total number of word units is being used, as each sub-document can have fewer duplicate word units.

### Document Management Actions

After using a containment coefficient to determine that one document is a template for a second document, a variety of document management actions are possible depending on the context. Document leakage prevention is one area of potential application. One or more groups of template documents can be identified that have varying levels of sensitivity. For example, one group of template documents may correspond to documents with a high level of sensitivity. For this first group of documents, access may be limited to certain users from identified locations. When an attempt is made to access a document, containment coefficients can be used to determine if the document corresponds to a template from the first group of templates. If the user and/or machine do not have the correct access rights, access to the file can be blocked. Additionally, a system administrator or another appropriate person can be notified of the access attempt. In this situation, document management actions include blocking access to the document and/or sending a notification. Other document management actions can include encrypting the file, placing the file under quarantine so that no user can access the file for a time period, or suspending/limiting activity by the user who attempted to access the file for a period of time. Another group of template documents can correspond to a second level of sensitivity. Documents having the second level of sensitivity can be used by anyone within the company (or another defined group), but should not be allowed to leave the company's (or group's) network. Containment coefficients can be used to compare template documents with any document that a user attempts to either e-mail to an outside address or download to a local hard drive, such as a removable media drive. If such an effort is made, the e-mail or download attempt can be blocked, and the user attempting the e-mail or download can be notified of the restriction. In this situation, document management actions can include blocking access to the file, sending a notification, or redacting the file to remove sensitive information. Still another type of document sensitivity can be for documents that can be sent to outside parties, but only after receiving additional confirmation from a user. For example, when a user attempts to download a document to a local drive (possibly including a removable media drive), or if the user attempts to e-mail the document to an e-mail address outside of a corporate network, containment coefficients can be used to determine if the document corresponds to a template. If the document is based on a template, the user can be provided with a dialog box informing the user of the nature of the document. The user can proceed with the download or e-mail, but only after confirming that the user would like to continue. In this situation, a document management action can be prompting the user for confirmation. Optionally, the user confirmations can be stored in a logfile, possibly along with the identity of the document and corresponding template. Another option could be to prompt the user for a password, to allow for encryption of the file by the user.

Another application for determining that documents are based on templates is in managing messages delivered to users, such as messages from a user interface. For example, a user may attempt to send an e-mail that contains sensitive information, such as a credit card or social security number. The e-mail server may be configured to identify sensitive information, and restrict the sending of such e-mails to addresses outside of a corporate network. Optionally, this function could be performed by a separate application working in conjunction with the e-mail program. When the user attempts to send the e-mail, the e-mail server may prevent the e-mail from being sent. A notification is then provided to the user. However, the e-mail program may still keep trying to send the e-mail, leading to repeated failures. In this situation, the text of the e-mail can be used as a dynamic template, and compared with the text of the e-mail being sent in the subsequent attempts. By identifying that the subsequent e-mail failures are based on an e-mail template corresponding to the initial failure, the number of subsequent warnings to the user can be reduced or eliminated altogether. Instead of continuing to provide the user with the same warning message about how an e-mail is not being sent, the user can receive the notification of the additional e-mail failures at a reduced frequency. Alternatively, all of the subsequent failure messages can be eliminated. In this situation, the document management action is elimination or blocking of one or more notifications to the user.

Note that in the above example, the template e-mail and the subsequent e-mails were identical. The template identification can also allow non-identical e-mails to be identified, and suppress the user notifications. For example, after receiving the initial notification that the e-mail has not been sent, the user may attempt to modify the e-mail and send it again. The modification may involve adding text, and/or small changes in the existing text. Such changes could still result in the containment coefficient having greater than a threshold value, so the subsequent e-mails could be identified as based on the original dynamic template, and once again the number of notifications sent to the user could be reduced.

### Example 1

### Identification of a Document that is Derived from a Template

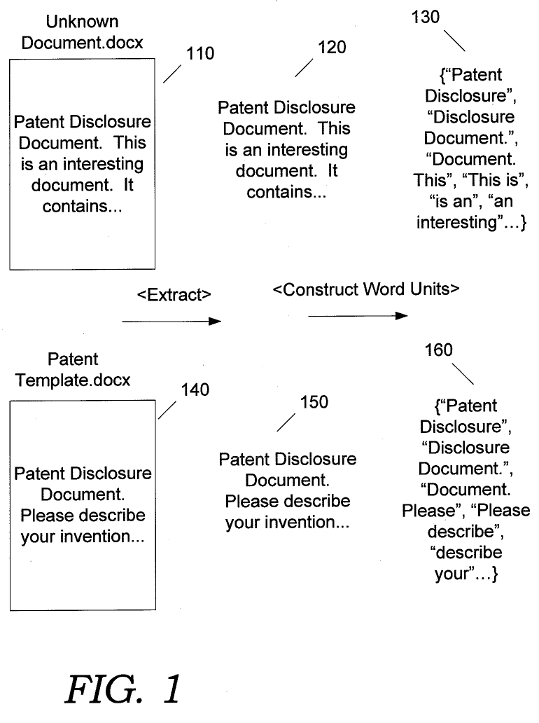

FIG. 1 schematically shows an example of the initial actions for determining that a hypothetical document of unknown contents is derived from a template document. In FIG. 1, document 110 represents a file Unknown Document.docx. The text from document 110 is extracted to provide extracted text 120. As shown in FIG. 1, the extracted text 120 starts with the text “Patent Disclosure Document. This is an interesting document. It contains . . . ”. A set of word units can then be built based on the extracted text. In FIG. 1, the word unit is defined as a pair of words. This leads to a set 130 of word units based on the document 110 that includes “Patent Disclosure”, “Disclosure Document.”, “Document. This”, “This is”, “is an”, “an interesting”, and so on. FIG. 1 also shows a template document 140, in the form of file Patent Template.docx. The text from document 140 can be extracted to form extracted text 150. The extracted text 150 can then be used to construct a set of word units 160 based on the template document 140.

Based on the set of word units 130 and the set of word units 160, a resemblance or similarity value can be calculated. The similarity value can be determined using the methods noted above. In this example, the similarity value for the two sets of word units is 0.25. Based on this similarity value, a containment coefficient can be calculated. In this example, the set 160 formed from template document 140 contains 127 word units, while the set 130 formed from unknown document 110 contains 500 word units. In this example, no effort is made to identify duplicate word units within set 130 or 160, so the total number of word units is used as the number of word units associated with each of the sets. These values lead to a containment coefficient of 0.99. The threshold value in this example is set at 0.75, so a value of 0.99 is greater than the threshold. As a result, the unknown document is considered to be based on the template document.

In the above example, the set 160 of word units for document 140 was calculated after the set 130 of word units for document 110. Alternatively, the set 160 of word units for document 140 could have been determined ahead of time. In many situations, template documents can have a stable content of text for long periods of time. In such situations, the set of word units can be determined and the fingerprint can be calculated in advance. The fingerprint and the number of word units in the set can then be distributed, possibly as part of a library of fingerprints for template documents, to any location that participates in comparing documents to a template documents.

### Example 2

### Use of a Fingerprint Library

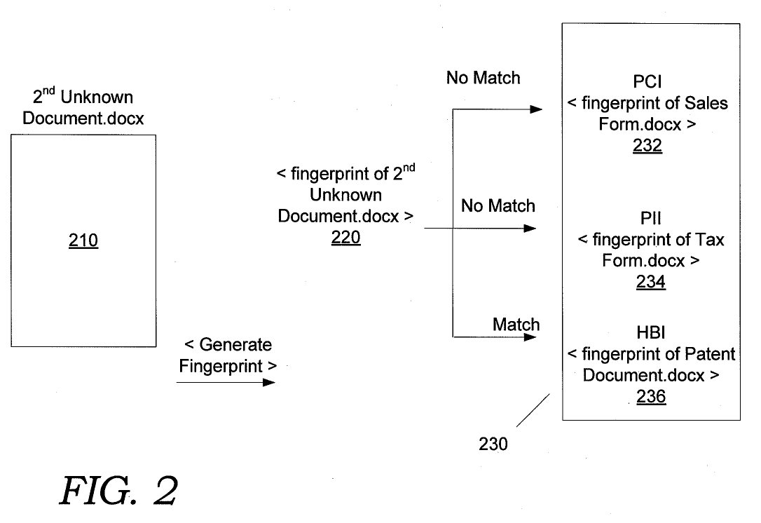

FIG. 2 schematically shows an example of determining whether a hypothetical document is based on a template document contained in a library of template documents. In FIG. 2, the document 210 for comparison is 2^{nd} Unknown Document.docx. Using methods described above, a fingerprint 220 is developed for document 210. The fingerprint in this example is a sequence of fingerprint values corresponding to the minimum value from each set of word unit hash values. The number of word units in the document 210 corresponding to fingerprint 220 is also determined. The fingerprint 220 can then be compared with a library 230 of fingerprints that correspond to various sensitive documents within a classification policy in an organization. Note that library 230 will also include the number of word units for the documents corresponding to each stored fingerprint. In FIG. 2, the library 230 includes a sales form document 232 that is classified as private customer information (PCI) under the classification policy. Tax form 234 represents a government tax document for an employee, such as a W-2, W-4, 1040, or another tax form. This form receives a classification of private individual information (PII) under the classification policy. Patent document 236 represents a form used in the evaluation of inventions within the organization. This form receives a classification as a high business impact (HBI) document under the classification policy. Of course, these classifications are examples, and other categories or classifications can be included within a classification policy.

In FIG. 2, the fingerprint 220 from document 210 is compared with one or more of the fingerprints in the library 230. A library of fingerprints can contain one or more fingerprints of template documents. Potentially, the fingerprint 220 could be compared with each fingerprint in library 230. Alternatively, the fingerprints from library 230 used for a comparison may be limited, such as only comparing to fingerprints from categories that are relevant to the document and/or the action being performed with a document. For example, if the action being performed with a document is that the document is being downloaded to a local hard drive, a comparison may only be needed against documents in the private individual information class. As another example, the original location of a document within a network or computer file system may indicate the appropriate categories of fingerprints for comparison. Still another option may be to compare a fingerprint with the entire library, so that an appropriate sensitivity classification can be assigned to a document.

The comparison with the fingerprints in the library allows a determination of whether a document is built upon one of the corresponding document templates. If a matching template document is identified, a document management action can be performed as described above. The type of document management action performed may depend on the classification of the template document that matches a comparison document. For example, if an e-mail is being sent to an outside address, inclusion of private individual information may be blocked entirely. Inclusion of private customer information may be limited to users with sufficient authority. Inclusion of high business impact documents may be permitted, but only after explicit acknowledgment by the user. In the example shown in FIG. 2, the unknown document 210 is being sent by e-mail to an outside address. The fingerprint 220 of document 210 is matched to library fingerprint 236, which corresponds to a patent document having a high business impact classification. The document 210 is therefore also assigned this classification. Based on this classification, the user sending the e-mail is prompted to confirm the sending of the e-mail. The confirmation, the identity of the user, the identity of the document, and the identity of the document template are then stored in a logfile for future reference.

A library of fingerprints, such as the library shown in FIG. 2, can be stored in one or more locations as appropriate. Since the library contains fingerprints (and corresponding counts of the number of word units), and not actual documents, the library takes little space. In many embodiments, there is also little or no risk that an original document can be constructed from a fingerprint. Thus, a library of fingerprints can be distributed widely to machines used by an organization in order to allow fingerprint comparisons in a convenient and secure manner.

### Method Examples

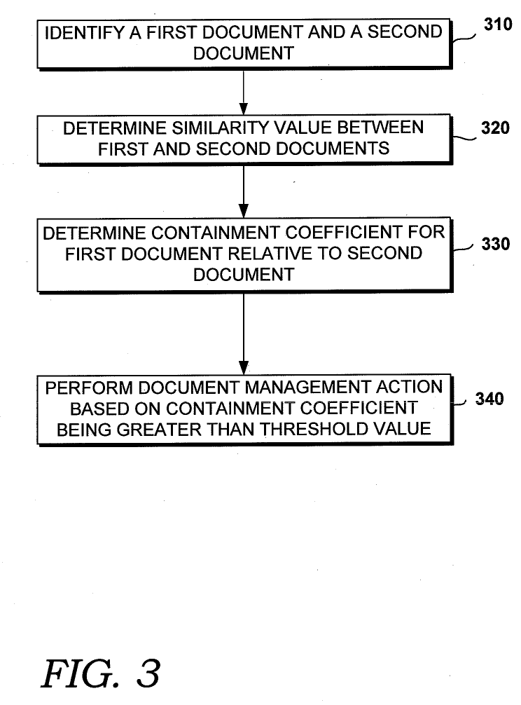

FIG. 3 schematically shows an example of a method according to an embodiment of the invention. In FIG. 3, a first document and a second document are identified 310. The first document can be identified in a variety of manners. The first document can be identified as being part of a library of documents for comparison. Alternatively, selected documents from a library can be identified, based on the nature of an action taken by the user and/or a property of the second document. In a situation involving a dynamic template document, the first document can be a document created by a user. The second document can be identified based on a user's attempt to access, send, use, or otherwise perform an action involving the document. Alternatively, the second document can represent a modification of the first document. A similarity value between the first and second documents is then determined 320. A containment coefficient is determined 330 for the first document relative to the second document. The containment coefficient can be based on the similarity value for the documents as well as the number of word units in the documents. A document management action is then performed 340 based on the containment coefficient being greater than a threshold value. If the containment coefficient is less than the threshold value, the second document is not based on the first document and no action is needed.

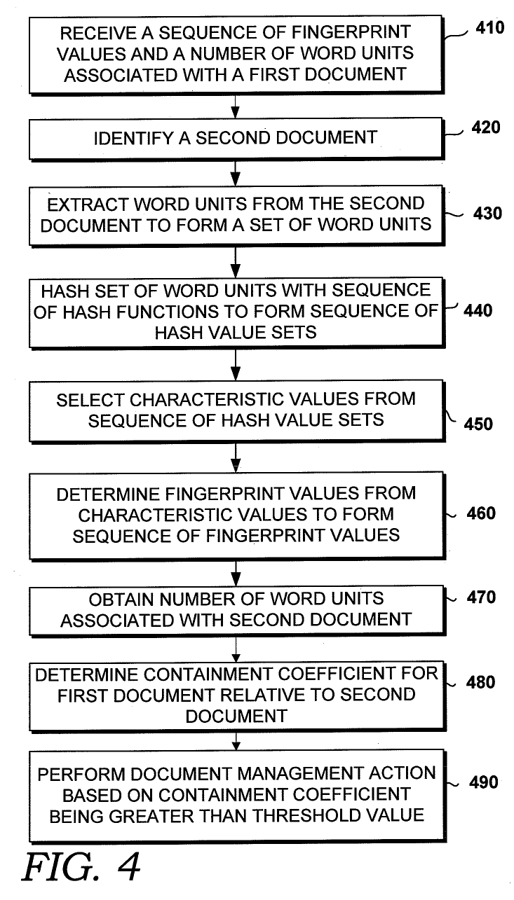

FIG. 4 schematically shows another example of a method according to an embodiment of the invention. In FIG. 4, a sequence of fingerprint values are received 410, as well as a number of word units associated with a first document. A second document is identified 420. Word units are extracted 430 from the second document to form a set of word units. The set of word units is hashed 440 with a sequence of hash functions to form a sequence of hash value sets. A characteristic value is selected 450 from each of the hash value sets. The minimum value in a hash set is an example of a possible characteristic value. A sequence of fingerprint values is formed 460 from the characteristic values to form a sequence of fingerprint values. For example, the sequence of fingerprint values can be a sequence of the characteristic values, or the characteristic values can also be transformed or truncated to form the sequence of fingerprint values. A number of word units associated with the second document is obtained 470. A containment coefficient is then determined 480 for the first document relative to the second document. The containment coefficient can be based on the sequences of fingerprint values associated with the first and second documents as well as the number of word units associated with the documents. For example, the sequences of fingerprint values can be used to determine a similarity value, which is then used for determining the containment coefficient. A document management action is then performed 490 based on the containment coefficient being greater than a threshold value.

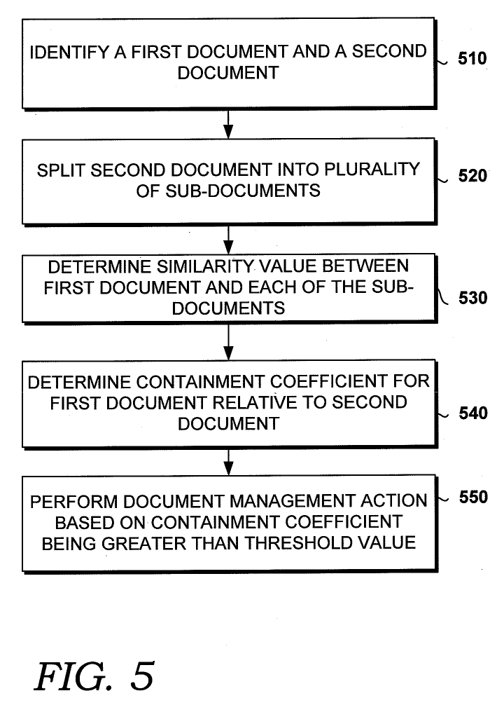

FIG. 5 schematically shows still another method according to an embodiment of the invention. In FIG. 5, a first document and a second document are identified 510. The second document is split 520 into a plurality of sub-documents. The plurality of sub-documents can each have an associated number of word units that is greater than or equal to the number of word units associated with the first document. A similarity value is the determined 530 between the first document and each of the sub-documents. A containment coefficient for the first document relative to the second document is determined 540. A document management action is then performed 550 based on the containment coefficient being greater than a threshold value.

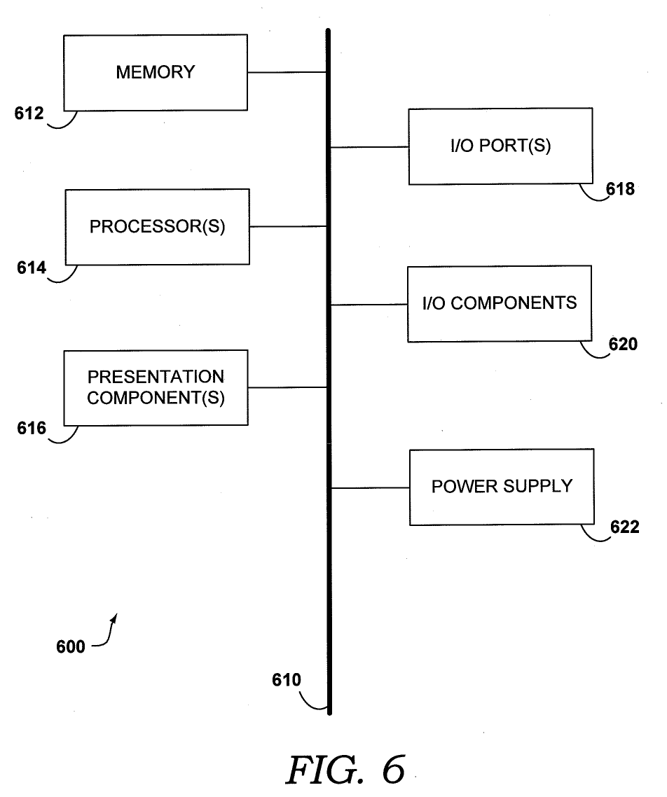

Having briefly described an overview of various embodiments of the invention, an exemplary operating environment suitable for performing the invention is now described. Referring to the drawings in general, and initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

The computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 600. In an embodiment, the computer storage media can be selected from tangible computer storage media. In another embodiment, the computer storage media can be selected from non-transitory computer storage media.

The memory 612 includes computer-storage media in the form of volatile and/or nonvolatile memory. The memory may be removable, non-removable, or a combination thereof. Exemplary hardware devices include solid-state memory, hard drives, optical-disc drives, etc. The computing device 600 includes one or more processors that read data from various entities such as the memory 612 or the I/O components 620. The presentation component(s) 616 present data indications to a user or other device. Exemplary presentation components include a display device, speaker, printing component, vibrating component, and the like.

The I/O ports 618 allow the computing device 600 to be logically coupled to other devices including the I/O components 620, some of which may be built in. Illustrative components include a microphone, joystick, game pad, satellite dish, scanner, printer, wireless device, etc.

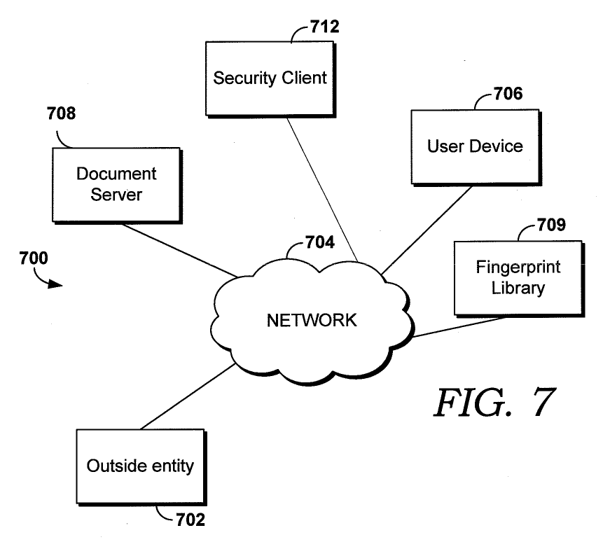

Turning now to FIG. 7, a block diagram is illustrated, in accordance with an embodiment of the present invention, showing an exemplary computing system 700. It will be understood and appreciated by those of ordinary skill in the art that the computing system 700 shown in FIG. 7 is merely an example of one suitable computing system environment and is not intended to suggest any limitation as to the scope of use or functionality of embodiments of the present invention. Neither should the computing system 700 be interpreted as having any dependency or requirement related to any single component or combination of components illustrated therein. Further, the computing system 700 may be provided as a stand-alone product, as part of a software development environment, or any combination thereof.

The computing system 700 includes a user device 706, a document server 708, a security client 712, and a fingerprint library 709, all in communication with one another via a network 704 and/or via location on a common device. Alternatively, one or more of user device 706, document server 708, security client 712, and fingerprint library 709 may be co-located on a single machine. Also shown is an outside entity 702, such as a computer having an e-mail address outside of the network. The network may include, without limitation, one or more local area networks (LANs) and/or wide area networks (WANs). Such networking environments are commonplace in offices, enterprise-wide computer networks, intranets and the Internet. Accordingly, the network 704 is not further described herein.

In an embodiment, a user may attempt to perform an action using user device 706. The action could be accessing a document, e-mailing a document, saving a document, or any other type of action. The document can be located on user device 706, or the document can be located on a separate document server 708. When the user performs an action on the document, security client 712 detects the action and attempts to apply any network security policies or user interface policies that have been implemented. In the embodiment shown in FIG. 7, the security client compares a fingerprint of the document with one or more fingerprints from fingerprint library 709. If a matching fingerprint is found, a document management action can be performed in accordance with the security policy or user interface policy.

Each of the user device 706, fingerprint library 709, security client 712, and document server 708 shown in FIG. 7 may be any type of computing device, such as, for example, computing device 600 described above with reference to FIG. 6. By way of example only and not limitation, each of the user device 706, fingerprint library 709, security client 712, and document server 708 may be a personal computer, desktop computer, laptop computer, handheld device, mobile handset, consumer electronic device, and the like. Additionally, the user device 706 may further include a keyboard, keypad, stylus, joystick, and any other input-initiating component that allows a user to provide wired or wireless data to the network 704, e.g., verification inquires, web page addresses, and the like. It should be noted, however, that the present invention is not limited to implementation on such computing devices, but may be implemented on any of a variety of different types of computing devices within the scope of embodiments hereof.

### Additional Embodiments

In an embodiment, one or more computer-storage media storing computer-useable instructions that, when executed by a computing device, perform a method for comparing documents are provided. The method performed includes identifying a first document and a second document; determining a similarity value between the first document and the second document; determining a containment coefficient for the first document relative to the second document based on the similarity value, a number of word units associated with the first document, and a number of word units associated with the second document, wherein the number of word units associated with the second document is greater than the number of word units associated with the first document; and performing a document management action based on the containment coefficient being greater than the threshold value, wherein the containment coefficient is defined as

Cᵣ=[R/1+R*(|Sₜ|+|S_{c}|)]/|Sₜ|

where R is the similarity value, |Sₜ| is the number of word units associated with the first document, and |S_{c}| is the number of word units associated with the second document.

In another embodiment, a method for comparing documents is provided. The method includes receiving a sequence of fingerprint values and a number of word units associated with a first document; identifying a second document; extracting word units from the second document to form a set of word units; hashing the set of word units with a sequence of hash functions to form a sequence of hash value sets; selecting a characteristic value from each hash value set to form a sequence of characteristic values; selecting a group of bits from each characteristic value to form a sequence of fingerprint values associated with the second document; obtaining a number of word units associated with the second document; determining a containment coefficient for the first document relative to the second document based on the sequence of fingerprint values associated with the first document, the number of word units associated with the first document, the sequence of fingerprint values associated with the second document, and the number of word units associated with the second document; and performing a document management action based on the containment coefficient being greater than the threshold value.

In still another embodiment, one or more computer-storage media storing computer-useable instructions that, when executed by a computing device, perform a method for comparing documents is provided. The method performed includes identifying a first document and a second document; splitting the second document into a plurality of sub-documents, wherein a number of word units associated with a sub-document is greater than or equal to a number of word units associated with the first document; determining a similarity value between the first document and each of the sub-documents to produce a plurality of similarity values; determining a containment coefficient for the first document relative to the second document based on the plurality of similarity values; and performing a document management action based on the containment coefficient being greater than the threshold value.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for comparing documents comprising:
identifying a first document and a second document;
determining a similarity value between the first document and the second document;
determining a containment coefficient for the first document relative to the second document based on the similarity value, a number of word units associated with the first document, and a number of word units associated with the second document; and
performing a document management action based on the containment coefficient being greater than the threshold value,
wherein the containment coefficient is defined as
Cᵣ=[R*(|Sₜ|+|S_{c}|)/(1+R)]/|Sₜ|

where R is the similarity value, |Sₜ| is the number of word units associated with the first document, and |S_{c}| is the number of word units associated with the second document.

2. The computer-storage media of claim 1, wherein determining a similarity value comprises:
obtaining a sequence of fingerprint values for the first document;
generating a sequence of fingerprint values for the second document; and
determining a similarity value based on the sequence of fingerprint values for the first document and the sequence of fingerprint values for the second document.

3. The computer-storage media of claim 2, wherein generating a sequence of fingerprint values for the second document comprises:
extracting word units from the second document;
identifying a plurality of hash functions for use in a sequence;
hashing the extracted word units with the sequence of hash functions to form a sequence of hash value sets;
selecting a characteristic value from each hash value set; and
forming a sequence of fingerprint values associated with the second document based on the selected characteristic values.

4. The computer-storage media of claim 3, wherein forming the sequence of fingerprint values comprises forming a sequence of the selected characteristic values.

5. The computer-storage media of claim 3, wherein forming the sequence of fingerprint values comprises transforming the selected characteristic values.

6. The computer-storage media of claim 3, wherein the number of word units associated with the second document corresponds to a total number of word units extracted from the second document.

7. The computer-storage media of claim 3, wherein the number of word units associated with the second document corresponds to a number of unique word units extracted from the second document.

8. The computer-storage media of claim 1, wherein determining a similarity value comprises:
obtaining a sequence of fingerprint values for the first document;
obtaining a sequence of fingerprint values for the second document; and
determining a similarity value based on the sequence of fingerprint values for the first document and the sequence of fingerprint values for the second document.

9. The computer-storage media of claim 1, wherein determining a similarity value comprises:
generating a sequence of fingerprint values for the first document;
generating a sequence of fingerprint values for the second document; and
determining a similarity value based on the sequence of fingerprint values for the first document and the sequence of fingerprint values for the second document.

10. The computer-storage media of claim 1, wherein performing a document management action comprises one or more of sending a notification, blocking an automatic notification, blocking a user-requested action involving the second document, or denying a user access to the second document.

11. The computer-storage media of claim 1, wherein the first document is a dynamic template document.

12. The computer-storage media of claim 1, wherein identifying a first document comprises:
receiving a library of sequences of fingerprint values, the sequences of fingerprint values being associated with corresponding numbers of word units;
selecting a sequence of fingerprint values and a corresponding number of word units for the first document from the library of sequences of fingerprint values.

13. A method for comparing documents comprising:
receiving a sequence of fingerprint values and a number of word units associated with a first document;
identifying a second document;
extracting word units from the second document to form a set of word units;
hashing the set of word units with a sequence of hash functions to form a sequence of hash value sets;
selecting a characteristic value from each hash value set to form a sequence of characteristic values;
forming a sequence of fingerprint values associated with the second document based on the selected characteristic values;
obtaining a number of word units associated with the second document;
determining a containment coefficient for the first document relative to the second document based on the sequence of fingerprint values associated with the first document, the number of word units associated with the first document, the sequence of fingerprint values associated with the second document, and the number of word units associated with the second document; and
performing a document management action based on the containment coefficient being greater than the threshold value.

14. The method of claim 13, wherein a word unit comprises from about one to about three words.

15. The method of claim 13, wherein a word unit comprises from about three to about twenty consecutive characters.

16. The method of claim 15, wherein the consecutive characters exclude non-alphabetic and non-numeric characters.

17. The method of claim 13, wherein the characteristic value from each hash value set is a minimum value.

18. The method of claim 13, wherein each hash function in the sequence of hash functions is different.

19. One or more computer-storage media storing computer-useable instructions that, when executed by a computing device, perform a method for comparing documents comprising:
identifying a first document and a second document;
splitting the second document into a plurality of sub-documents;
determining a similarity value between the first document and each of the sub-documents to produce a plurality of similarity values;
determining a containment coefficient for the first document relative to the second document based on the plurality of similarity values; and
performing a document management action based on the containment coefficient being greater than the threshold value.

20. The computer-storage media of claim 19, wherein determining a containment coefficient based on the plurality of similarity values comprises:
determining a containment coefficient for the first document relative to each sub-document based on the similarity value, a number of word units associated with the first document, and a number of word units associated with the sub-document;
calculating a correction factor based on the sub-documents; and
combining the determined containment coefficients and the correction factor to generate an overall containment coefficient.
